(19) United States
(12) Patent Application Publication
(10) Pub. No.: US 2015/0197677 A1
(43) Pub. Date: Jul. 16, 2015

(54) COMPOSITIONS COMPRISING Z-1,1,1,4,4,4-HEXAFLUORO-2-BUTENE AND 2,2-DICHLORO-1,1,1-TRIFLUOROETHANE AND METHODS OF USE THEREOF

(71) Applicant: E I DU PONT DE NEMOURS AND COMPANY, Wilmington, DE (US)

(72) Inventor: Konstantinos Kontomaris, Wilmington, DE (US)

(21) Appl. No.: 14/422,261

(22) PCT Filed: Sep. 18, 2013
(86) PCT No.: PCT/US2013/060299

§ 371 Date: Feb. 18, 2015

Related U.S. Application Data
(60) Provisional application No. 61/702,975, filed on Sep. 19, 2012.

(51) Int. Cl. C09K 5/04; F25B 45/00

(52) U.S. Cl. CPC C09K 5/044; F25B 45/00; C09K 2205/24; C09K 2205/32; C09K 2205/12; C09K 2205/40; F25B 2345/001

(57) ABSTRACT

In accordance with the present invention a composition is provided. The composition comprises Z-1,1,1,4,4,4-hexafluoro-2-butene (Z-HFO-1336mzz) and 2,2-dichloro-1,1,1-trifluoroethane (HCFC-123). Also in accordance with the present invention a method is provided for topping-off or replenishing a refrigerant charge. The method comprises adding a second refrigerant to a refrigeration, air conditioning, heat pump or power cycle system containing HCFC-123 as a first refrigerant, wherein said second refrigerant comprises Z-HFO-1336mzz and optionally HCFC-123, thus producing a refrigerant composition comprising the first refrigerant and the second refrigerant. Also in accordance with the present invention another method is provided. The method comprises replacing HCFC-123 in a refrigeration, air conditioning, heat pump or power cycle system with a refrigerant composition comprising Z-HFO-1336mzz and optionally HCFC-123.

### BACKGROUND

1. Field of the Disclosure

The present disclosure relates to compositions comprising Z-1,1,1,4,4,4-hexafluoro-2-butene and 2,2-dichloro-1,1,1-trifluoroethane and uses thereof for topping-off or replenishing the refrigerant charge in equipment designed to use 2,2-dichloro-1,1,1-trifluoroethane. The methods of the present invention are useful for adding or topping off refrigerants in refrigeration, air conditioning, heat pump or power cycle apparatus.

2. Description of Related Art

The refrigeration industry has been working for the past few decades to find replacement refrigerants for the ozone-depleting chlorofluorocarbons (CFCs) and hydrochlorofluorocarbons (HCFCs) being phased out as a result of the Montreal Protocol. The solution for most refrigerant producers has been the commercialization of hydrofluorocarbon (HFC) refrigerants. The new HFC refrigerants, HFC-134a being the most widely used at this time, have zero ozone depletion potential and thus are not affected by the current regulatory phase out as a result of the Montreal Protocol.

Further environmental regulations may ultimately cause global phase out of certain HFC refrigerants. Currently, industry is facing regulations relating to global warming potential (GWP) and ozone depletion potential (ODP) for refrigerants. Should the regulations be more broadly applied in the future, an even greater need will be felt for refrigerants that can be used in all areas of the refrigeration and air-conditioning industry. Uncertainty as to the ultimate regulatory requirements relative to GWP and ODP has forced the industry to consider multiple candidate compounds and mixtures.

As the use of certain refrigerants is banned or restricted, there is a need for refrigerants that are compatible with existing equipment. During regular operation, refrigerants can escape the system, requiring new refrigerant to be added. If the original refrigerant is only available in limited quantities or no longer available, then a compatible refrigerant must be identified or the equipment will need to be modified or replaced to provide comparable performance.

Chillers operating with HCFC-123 as the working fluid are in widespread use today. The working fluid charge of such chillers needs to be periodically replenished because of fluid losses originating from at least two causes: (a) the evaporators of chillers with HCFC-123 as the working fluid normally operate at pressures below the surrounding atmospheric pressure. As a result, air can infiltrate into such chillers with detrimental effects on chiller performance. Chillers with HCFC-123 as the working fluid are usually equipped with purge systems to remove infiltrating air. Invariably, some HCFC-123 is purged along with the undesirable non-condensable gases; and (b) occasionally some portion of the working fluid charge leaks accidentally. Consequently, the chiller HCFC-123 charge needs to be periodically replenished to maintain chiller performance.

HCFC-123 is an ozone depleting substance under the Montreal protocol. It cannot be used in new equipment in the European Union today and the US after 2020. Furthermore, HCFC-123 production is scheduled for phase-out by 2030. It is possible that additional restrictions in various countries may further restrict the availability of HCFC-123 for various uses including use as a service fluid for replenishing the charge of existing HCFC-123 chillers. There is, therefore, a need for an alternative method for restoring the performance of HCFC-123 chillers with diminished HCFC-123 charges other than by replenishing the diminished HCFC-123 charge with additional HCFC-123 fluid.

### BRIEF SUMMARY

Certain existing refrigerants have been found to possess suitable properties to allow their use as a replacement for 2,2-dichloro-1,1,1-trifluoroethane. Additionally, these refrigerants may provide appropriate refrigerant charge top-off candidates.

In accordance with the present invention a composition is provided. The composition comprises Z-1,1,1,4,4,4-hexafluoro-2-butene (Z-HFO-1336mzz) and 2,2-dichloro-1,1,1-trifluoroethane (HCFC-123).

Also in accordance with the present invention a method is provided for topping-off or replenishing a refrigerant charge. The method comprises adding a second refrigerant to a refrigeration, air conditioning, heat pump or power cycle system containing HCFC-123 as a first refrigerant, wherein said second refrigerant comprises Z-HFO-1336mzz and optionally HCFC-123, thus producing a refrigerant composition comprising the first refrigerant and the second refrigerant.

Also in accordance with the present invention another method is provided. The method comprises replacing HCFC-123 in a refrigeration, air conditioning, heat pump or power cycle system with a refrigerant composition comprising Z-HFO-1336mzz and optionally HCFC-123.

### BRIEF DESCRIPTION OF THE DRAWINGS

FIG. 1 shows the variation of the dew point and bubble point pressure (in psia) of HCFC-123/Z-HFO-1336mzz compositions with Z-HFO-1336mzz mole fraction, at a temperature of 40.02° C.

### DETAILED DESCRIPTION

Before addressing details of embodiments described below, some terms are defined or clarified.

### DEFINITIONS

As used herein, the term heat transfer fluid means a composition used to carry heat from a heat source to a heat sink.

A heat source is defined as any space, location, object, stream or body from which it is desirable to transfer, move or remove heat. Examples of heat sources are spaces (open or enclosed) requiring refrigeration or cooling, such as refrigerator or freezer cases in a supermarket or building spaces requiring air conditioning. In some embodiments, the heat transfer composition may remain in a constant state of molecular aggregation throughout the heat transfer process (i.e., not evaporate or condense). In other embodiments, evaporative cooling processes may utilize heat transfer compositions as well.

A heat sink is defined as any space, location, object, stream or body capable of absorbing heat. The condenser cooling water of a vapor compression refrigeration system is one example of such a heat sink.

A refrigerant is defined as a heat transfer fluid that undergoes a phase change from liquid to gas and back again during the cycle used to transfer heat.

A refrigerant charge is the total amount of refrigerant loaded into equipment in order for the equipment to operate with maximum performance. Topping-off or replenishing the refrigerant charge refers to adding refrigerant to return a system to maximum performance when some portion of the charge is lost or leaked from the equipment.

A heat transfer system is a system (or apparatus) used to produce a heating or cooling effect in a particular space. A heat transfer system may be a mobile system or a stationary system. Examples of heat transfer systems are any type of refrigeration systems and air conditioning systems including, but are not limited to, air conditioners, freezers, refrigerators, heat pumps, water chillers, flooded evaporator chillers, direct expansion chillers, walk-in coolers, mobile refrigerators, mobile air conditioning units, dehumidifiers, and combinations thereof. Even a power cycle system, e.g. organic Rankine cycle, may fall under the broad classification of a heat transfer system, in which heat is transferred and partially converted to mechanical energy.

As used herein, mobile heat transfer system refers to any refrigeration, air conditioner or heating apparatus incorporated into a transportation unit for the road, rail, sea or air. In addition, mobile refrigeration or air conditioner units, include those apparatus that are independent of any moving carrier and are known as “intermodal” systems. Such intermodal systems include “container” (combined sea/land transport) as well as “swap bodies” (combined road/rail transport).

As used herein, stationary heat transfer systems are systems that are fixed in place during operation. A stationary heat transfer system may be associated with or attached to buildings of any variety or may be stand-alone devices located out of doors, such as a soft drink vending machine. These stationary applications may be stationary air conditioning and heat pumps, including but not limited to chillers, high temperature heat pumps, residential, commercial or industrial air conditioning systems (including residential heat pumps), and including window, ductless, ducted, packaged terminal, and those exterior but connected to the building such as rooftop systems. In stationary refrigeration applications, the disclosed compositions may be useful in equipment including commercial, industrial or residential refrigerators and freezers, ice machines, self-contained coolers and freezers, flooded evaporator chillers, direct expansion chillers, walk-in and reach-in coolers and freezers, and combination systems. In some embodiments, the disclosed compositions may be used in supermarket refrigeration systems. Additionally, stationary applications may utilize a secondary loop system that uses a primary refrigerant to produce cooling in one location that is transferred to a remote location via a secondary heat transfer fluid.

Refrigeration capacity (also referred to as cooling capacity) is a term which defines the change in enthalpy of a refrigerant in an evaporator per pound of refrigerant circulated, or the heat removed by the refrigerant in the evaporator per unit volume of refrigerant vapor exiting the evaporator (volumetric capacity). The refrigeration capacity is a measure of the ability of a refrigerant or heat transfer composition to produce cooling. Therefore, the higher the capacity, the greater the cooling that is produced. Cooling rate refers to the heat removed by the refrigerant in the evaporator per unit time.

Coefficient of performance (COP) for cooling is the amount of heat removed at the evaporator divided by the required energy input to operate the compressor of the cycle. The higher the COP, the higher is the energy efficiency. COP is directly related to the energy efficiency ratio (EER) that is the efficiency rating for refrigeration or air conditioning equipment at a specific set of internal and external temperatures.

The term “subcooling” refers to the reduction of the temperature of a liquid below that liquid's saturation point for a given pressure. The saturation point is the temperature at which the vapor is completely condensed to a liquid, but subcooling continues to cool the liquid to a lower temperature liquid at the given pressure. By cooling a liquid below the saturation temperature (or bubble point temperature), the net refrigeration capacity can be increased. Subcooling thereby improves refrigeration capacity and energy efficiency of a system. Subcool amount is the amount of cooling below the saturation temperature (in degrees).

Superheat is a term that defines how far above its saturation vapor temperature (the temperature at which, if the composition is cooled, the first drop of liquid is formed, also referred to as the “dew point”) a vapor composition is heated.

Temperature glide (sometimes referred to simply as “glide”) is the absolute value of the difference between the starting and ending temperatures of a phase-change process by a refrigerant within a component of a refrigerant system, exclusive of any subcooling or superheating. This term may be used to describe condensation or evaporation of a near azeotrope or non-azeotropic composition. When referring to the temperature glide of a refrigeration, air conditioning or heat pump system, it is common to provide the average temperature glide being the average of the temperature glide in the evaporator and the temperature glide in the condenser.

By azeotropic composition is meant a constant-boiling mixture of two or more substances that behave as a single substance. One way to characterize an azeotropic composition is that the vapor produced by partial evaporation or distillation of the liquid has the same composition as the liquid from which it is evaporated or distilled, i.e., the mixture distills/refluxes without compositional change. Constant-boiling compositions are characterized as azeotropic because they exhibit either a maximum or minimum boiling point, as compared with that of the non-azeotropic mixture of the same compounds. An azeotropic composition will not fractionate within a refrigeration or air conditioning system during operation. Additionally, an azeotropic composition will not fractionate upon leakage from a refrigeration or air conditioning system.

An azeotrope-like composition (also commonly referred to as a “near-azeotropic composition”) is a substantially constant boiling liquid mixture of two or more substances that behaves essentially as a single substance. One way to characterize an azeotrope-like composition is that the vapor produced by partial evaporation or distillation of the liquid has substantially the same composition as the liquid from which it was evaporated or distilled, that is, the admixture distills/refluxes without substantial composition change. Another way to characterize an azeotrope-like composition is that the bubble point vapor pressure and the dew point vapor pressure of the composition at a particular temperature are substantially the same. Herein, a composition is azeotrope-like if, during use in refrigeration, air conditioning, heat pump or power cycle systems, the temperature glide in the heat exchangers averages 1° C. or less. More specifically, a composition is considered nearly azeotropic or azeotrope-like if the average evaporator and condenser temperature glide under typical chiller conditions is lower than 1° C.

A non-azeotropic (also referred to as zeotropic) composition is a mixture of two or more substances that behaves as a simple mixture rather than a single substance. One way to characterize a non-azeotropic composition is that the vapor produced by partial evaporation or distillation of the liquid has a substantially different composition as the liquid from which it was evaporated or distilled, that is, the mixture distills/refluxes with substantial composition change. Another way to characterize a non-azeotropic composition is that the bubble point vapor pressure and the dew point vapor pressure of the composition at a particular temperature are substantially different. Herein, a composition is non-azeotropic if, during use in a refrigeration, air conditioning, heat pump or power cycle system, the temperature glide in the heat exchangers averages greater than 1° C.

As used herein, the term “lubricant” means any material added to a composition or a compressor (and in contact with any heat transfer composition in use within any heat transfer system) that provides lubrication to the compressor.

As used herein, compatibilizers are compounds which improve solubility of the hydrofluorocarbon of the disclosed compositions in heat transfer system lubricants. In some embodiments, the compatibilizers improve oil return to the compressor. In some embodiments, the composition is used with a system lubricant to reduce oil-rich phase viscosity.

As used herein, oil-return refers to the ability of a heat transfer composition to carry lubricant through a heat transfer system and return it to the compressor. That is, in use, it is not uncommon for some portion of the compressor lubricant to be carried away by the heat transfer composition from the compressor into the other portions of the system. In such systems, if the lubricant is not efficiently returned to the compressor, the compressor will eventually fail due to lack of lubrication.

As used herein, “ultra-violet” dye is defined as a UV fluorescent or phosphorescent composition that absorbs light in the ultra-violet or “near” ultra-violet region of the electromagnetic spectrum. The fluorescence produced by the UV fluorescent dye under illumination by a UV light that emits at least some radiation with a wavelength in the range of from 10 nanometers to about 775 nanometers may be detected.

Flammability is a term used to mean the ability of a composition to ignite and/or propagate a flame. For refrigerants and other heat transfer compositions, the lower flammability limit (“LFL”) is the minimum concentration of the heat transfer composition in air that is capable of propagating a flame through a homogeneous mixture of the composition and air under test conditions specified in ASTM (American Society of Testing and Materials) E681-04. The upper flammability limit (“UFL”) is the maximum concentration of the heat transfer composition in air that is capable of propagating a flame through a homogeneous mixture of the composition and air under the same test conditions. In order to be classified by ASHRAE (American Society of Heating, Refrigerating and Air-Conditioning Engineers) as non-flammable, a refrigerant must be non-flammable under the conditions of ASTM E681-04 as formulated in the liquid and vapor phase as well as non-flammable in both the liquid and vapor phases that result during leakage scenarios.

Global warming potential (GWP) is an index for estimating relative global warming contribution due to atmospheric emission of a kilogram of a particular greenhouse gas compared to emission of a kilogram of carbon dioxide. GWP can be calculated for different time horizons showing the effect of atmospheric lifetime for a given gas. The GWP for the 100 year time horizon is commonly the value referenced. For mixtures, a weighted average can be calculated based on the individual GWPs for each component.

Ozone depletion potential (ODP) is a number that refers to the amount of ozone depletion caused by a substance. The ODP is the ratio of the impact on ozone of a chemical compared to the impact of a similar mass of CFC-11 (fluorotrichloromethane). Thus, the ODP of CFC-11 is defined to be 1.0. Other CFCs and HCFCs have ODPs that range from 0.01 to 1.0. HFCs have zero ODP because they do not contain chlorine.

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method or apparatus that includes materials, steps, features, components, or elements, in addition to those literally disclosed provided that these additional included materials, steps, features, components, or elements do materially affect the basic and novel characteristic(s) of the claimed invention. The term ‘consisting essentially of’ occupies a middle ground between “comprising” and ‘consisting of’. Typically, components of the refrigerant mixtures and the refrigerant mixtures themselves can contain minor amounts (e.g., less than about 0.5 weight percent total) of impurities and/or byproducts (e.g., from the manufacture of the refrigerant components or reclamation of the refrigerant components from other systems) which do not materially affect the novel and basic characteristics of the refrigerant mixture.

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the disclosed compositions, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

Compositions A composition comprising Z-1,1,1,4,4,4-hexafluoro-2-butene (Z-HFO-1336mzz) and 2,2-dichloro-1,1,1-trifluoroethane (HCFC-123) is provided.

Z-1,1,1,4,4,4-hexafluoro-2-butene, also known as cis-1,1,1,4,4,4-hexafluoro-2-butene or Z-HFO-1336mzz, may be made by methods known in the art, such as described in U.S. Patent Application Publication No. US 2009/0012335 A1, by hydrodechlorination of 2,3-dichloro-1,1,1,4,4,4-hexafluoro-2-butene.

2,2-Dichloro-1,1,1-trifluoroethane, also known as HCFC-123 or R-123, is available commercially or may be made by methods known in the art. HCFC-123 may be made, for instance, by fluorination of tetrachloroethylene or CF₂ClCHCl2 in the presence of a catalyst such as TaF₅ as described in U.S. Pat. No. 4,967,024, incorporated herein by reference.

It has been surprisingly found that compositions containing from about 1 weight percent to about 99 weight percent Z-HFO-1336mzz and from about 99 weight percent to about 1 weight percent HCFC-123 exhibit azeotropic or azeotrope-like characteristics that make the use of such compositions attractive for use in a refrigeration, air conditioning, heat pump or power cycle system. Thus, an azeotropic or azeotrope-like composition is provided comprising from about 1 weight percent to about 99 weight percent Z-HFO-1336mzz and from about 99 weight percent to about 1 weight percent HCFC-123. These compositions provide performance in refrigeration, air conditioning, heat pump or power cycle systems with temperature glide of less than 1° C. in the heat exchangers of the systems (for the embodiment in which the system is a power cycle system, at least one compressor may be replaced with an expander for conversion of heat to mechanical energy).

In another embodiment, the composition comprises from about 1 to about 60 weight percent Z-HFO-1336mzz and about 99 to about 40 weight percent HCFC-123 and the temperature glide achievable is less than about 0.7° C.

In another embodiment, the composition comprises from about 1 to about 50 weight percent Z-HFO-1336mzz and about 99 to about 50 weight percent HCFC-123 and the temperature glide achievable is less than about 0.5° C.

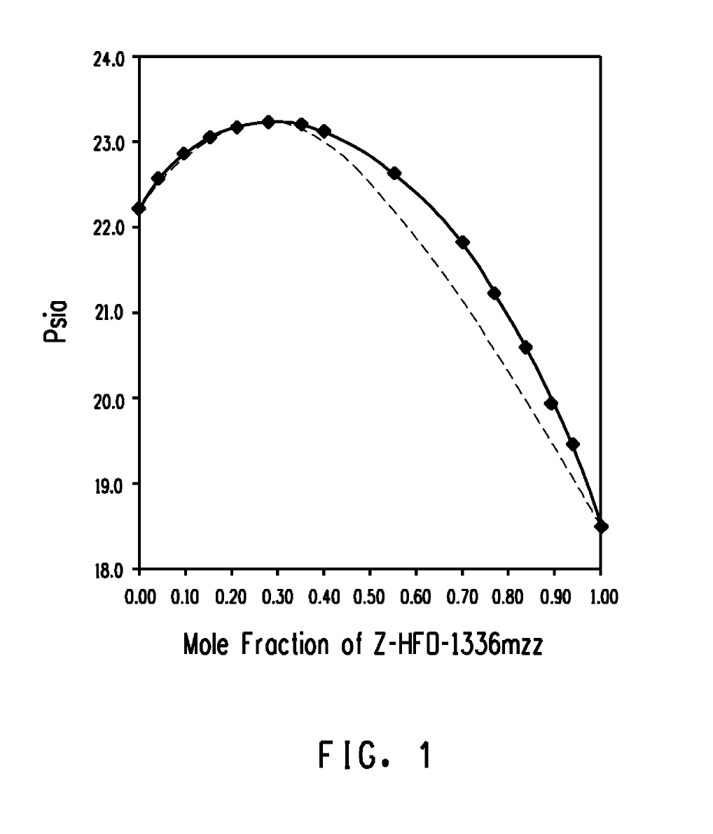

In another embodiment, the composition comprises from about 1 to about 42 weight percent Z-HFO-1336mzz and about 99 to about 58 weight percent HCFC-123 and the temperature glide achievable is less than about 0.15° C. Referring to FIG. 1, it can be seen that the full range of compositions containing Z-HFO-1336mzz and HCFC-123 are azeotropic or azeotrope-like. In fact, compositions containing less than about 40 mole percent Z-HFO-1336mzz (equivalent to about 42 weight percent) are azeotropic or azeotrope-like with average temperature glides produced in heat transfer equipment below 0.15° C. as stated above. These compositions with such low temperature glides would be preferred in the methods and apparatus of the present invention.

In one embodiment, the compositions comprising Z-HFO-1336mzz and HCFC-123 further comprise at least one hydrocarbon with 3 to 15 carbon atoms. Such hydrocarbons include propane, propylene, cyclopropane and others selected from the group consisting of n-butane, isobutane, n-pentane, isopentane, hexanes, octanes, nonane, and decanes, among others. In another embodiment, compositions comprising Z-HFO-1336mzz and HCFC-123 further comprise at least one hydrocarbon with 4 to 7 carbon atoms. In particular these hydrocarbons include n-butane, isobutane, n-pentane, isopentane, hexanes and heptanes.

In one embodiment, the present compositions comprising Z-HFO-1336mzz and HCFC-123 further comprise at least one lubricant suitable for use in a refrigeration, air conditioning, heat pump or power cycle system.

In some embodiments, the lubricant is a mineral oil lubricant. In some embodiments, the mineral oil lubricant is selected from the group consisting of paraffins (including straight carbon chain saturated hydrocarbons, branched carbon chain saturated hydrocarbons, and mixtures thereof), naphthenes (including saturated cyclic and ring structures), aromatics (those with unsaturated hydrocarbons containing one or more ring, wherein one or more ring is characterized by alternating carbon-carbon double bonds) and non-hydrocarbons (those molecules containing atoms such as sulfur, nitrogen, oxygen and mixtures thereof), and mixtures and combinations of thereof.

Some embodiments may contain one or more synthetic lubricant. In some embodiments, the synthetic lubricant is selected from the group consisting of alkyl substituted aromatics (such as benzene or naphthalene substituted with linear, branched, or mixtures of linear and branched alkyl groups, often generically referred to as alkylbenzenes), synthetic paraffins and napthenes, poly (alpha olefins), polyglycols (including polyalkylene glycols), dibasic acid esters, polyesters, polyol esters, neopentyl esters, polyvinyl ethers (PVEs), silicones, silicate esters, fluorinated compounds, phosphate esters, polycarbonates and mixtures thereof, meaning mixtures of the any of the lubricants disclosed in this paragraph.

The lubricants as disclosed herein may be commercially available lubricants. For instance, the lubricant may be paraffinic mineral oil, sold by BVA Oils as BVM 100 N, naphthenic mineral oils sold by Crompton Co. under the trademarks Suniso® 1 GS, Suniso® 3GS and Suniso® 5GS, naphthenic mineral oil sold by Pennzoil under the trademark Sontex® 372LT, naphthenic mineral oil sold by Calumet Lubricants under the trademark Calumet® RO-30, linear alkylbenzenes sold by Shrieve Chemicals under the trademarks Zerol® 75, Zerol® 150 and Zerol® 500 and branched alkylbenzene sold by Nippon Oil as HAB 22, polyol esters (POEs) sold under the trademark Castrol® 100 by Castrol, United Kingdom, polyalkylene glycols (PAGs) such as RL-488A from Dow (Dow Chemical, Midland, Mich.), and mixtures thereof, meaning mixtures of any of the lubricants disclosed in this paragraph.

The lubricants used with the present invention may be designed for use with hydrofluorocarbon refrigerants and may be miscible with compositions as disclosed herein under compression refrigeration and air-conditioning apparatus' operating conditions. In some embodiments, the lubricants are selected by considering a given compressor's or expander's requirements and the environment to which the lubricant will be exposed.

Notwithstanding the above weight ratios for compositions disclosed herein, it is understood that in some heat transfer systems, while the composition is being used, it may acquire additional lubricant from one or more equipment components of such heat transfer system. For example, in some refrigeration, air conditioning, heat pump or power cycle systems, lubricants may be charged in the compressor and/or the compressor lubricant sump or the expander. Such lubricant would be in addition to any lubricant additive present in the refrigerant in such a system. In use, the refrigerant composition when in the compressor or the expander may pick up an amount of the equipment lubricant to change the refrigerant-lubricant composition from the starting ratio.

In some embodiments, the compositions including R123 and a second refrigerant may include optional non-refrigerant components (also referred to herein as additives). The optional non-refrigerant components in the compositions disclosed herein may comprise one or more components selected from the group consisting of dyes (including UV dyes), solubilizing agents, compatibilizers, stabilizers, tracers, perfluoropolyethers, anti-wear agents, extreme pressure agents, corrosion and oxidation inhibitors, metal surface energy reducers, metal surface deactivators, free radical scavengers, foam control agents, viscosity index improvers, pour point depressants, detergents, viscosity adjusters, and mixtures thereof. Indeed, many of these optional non-refrigerant components fit into one or more of these categories and may have qualities that lend themselves to achieve one or more performance characteristic.

In some embodiments, one or more non-refrigerant components are present in small amounts relative to the overall composition. In some embodiments, the amount of additive(s) concentration in the disclosed compositions is from less than about 0.1 weight percent to as much as about 5 weight percent of the total composition. In some embodiments of the present invention, the additives are present in the disclosed compositions in an amount between about 0.1 weight percent to about 5 weight percent of the total composition or in an amount between about 0.1 weight percent to about 3.5 weight percent. The additive component(s) selected for the disclosed composition is selected on the basis of the utility and/or individual equipment components or the system requirements.

In some of the compositions of the present invention including a lubricant, the lubricant is present in an amount of less than 5.0 weight percent to the total composition. In other embodiments, the amount of lubricant is between about 0.1 and 3.5 weight percent of the total composition.

The non-refrigerant component used with the compositions of the present invention may include at least one dye. The dye may be at least one ultra-violet (UV) dye. The UV dye may be a fluorescent dye. The fluorescent dye may be selected from the group consisting of naphthalimides, perylenes, coumarins, anthracenes, phenanthracenes, xanthenes, thioxanthenes, naphthoxanthenes, fluoresceins, and derivatives of said dye, and combinations thereof, meaning mixtures of any of the foregoing dyes or their derivatives disclosed in this paragraph.

In some embodiments, the disclosed compositions contain from about 0.001 weight percent to about 1.0 weight percent UV dye. In other embodiments, the UV dye is present in an amount of from about 0.005 weight percent to about 0.5 weight percent; and in other embodiments, the UV dye is present in an amount of from 0.01 weight percent to about 0.25 weight percent of the total composition.

UV dye is a useful component for detecting leaks of the composition by permitting one to observe the fluorescence of the dye at or in the vicinity of a leak point in an apparatus (e.g., refrigeration unit, air-conditioner or heat pump). The UV emission, e.g., fluorescence from the dye may be observed under an ultra-violet light. Therefore, if a composition containing such a UV dye is leaking from a given point in an apparatus, the fluorescence can be detected at the leak point, or in the vicinity of the leak point.

Another non-refrigerant component which may be used with the compositions of the present invention may include at least one solubilizing agent selected to improve the solubility of one or more dye in the disclosed compositions. In some embodiments, the weight ratio of dye to solubilizing agent ranges from about 99:1 to about 1:1. The solubilizing agents include at least one compound selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers and 1,1,1-trifluoroalkanes and mixtures thereof, meaning mixtures of any of the solubilizing agents disclosed in this paragraph.

In some embodiments, the non-refrigerant component comprises at least one compatibilizer to improve the compatibility of one or more lubricants with the disclosed compositions. The compatibilizer may be selected from the group consisting of hydrocarbons, hydrocarbon ethers, polyoxyalkylene glycol ethers (such as dipropylene glycol dimethyl ether), amides, nitriles, ketones, chlorocarbons (such as methylene chloride, trichloroethylene, chloroform, or mixtures thereof), esters, lactones, aromatic ethers, fluoroethers, 1,1,1-trifluoroalkanes, and mixtures thereof, meaning mixtures of any of the compatibilizers disclosed in this paragraph.

The solubilizing agent and/or compatibilizer may be selected from the group consisting of hydrocarbon ethers consisting of the ethers containing only carbon, hydrogen and oxygen, such as dimethyl ether (DME) and mixtures thereof, meaning mixtures of any of the hydrocarbon ethers disclosed in this paragraph.

The compatibilizer may be linear or cyclic aliphatic or aromatic hydrocarbon compatibilizer containing from 3 to 15 carbon atoms. However, for the HFC and HFO refrigerants, hydrocarbons with 3 to 15 carbon atoms, including propane, propylene, cyclopropane and others selected from the group consisting of n-butane, isobutane, n-pentane, isopentane, hexanes, octanes, nonane, and decanes, among others. In another embodiment, the hydrocarbons have 4 to 7 carbon atoms. Commercially available hydrocarbon compatibilizers include but are not limited to those from Exxon Chemical (USA) sold under the trademarks Isopar® H, a mixture of undecane (C₁₁) and dodecane (C₁₂) (a high purity C₁₁ to C₁₂ iso-paraffinic), Aromatic 150 (a C₉ to C₁₁ aromatic) (, Aromatic 200 (a C₉ to C₁₅ aromatic) and Naptha 140 (a mixture of C₅ to C₁₁ paraffins, naphthenes and aromatic hydrocarbons) and mixtures thereof, meaning mixtures of any of the hydrocarbons disclosed in this paragraph.

The compatibilizer may alternatively be at least one polymeric compatibilizer. The polymeric compatibilizer may be a random copolymer of fluorinated and non-fluorinated acrylates, wherein the polymer comprises repeating units of at least one monomer represented by the formulae CH₂═C(R¹)CO₂R², CH₂═C(R³)C₆H₄R⁴, and CH₂═C(R⁵)C₆H₄XR⁶, wherein X is oxygen or sulfur; R¹, R³, and R⁵ are independently selected from the group consisting of H and C₁-C₄ alkyl radicals; and R², R⁴, and R⁶ are independently selected from the group consisting of carbon-chain-based radicals containing C, and F, and may further contain H, Cl, ether oxygen, or sulfur in the form of thioether, sulfoxide, or sulfone groups and mixtures thereof. Examples of such polymeric compatibilizers include those commercially available from E. I. du Pont de Nemours and Company, (Wilmington, Del., 19898, USA) under the trademark Zonyl® PHS. Zonyl® PHS is a random copolymer made by polymerizing 40 weight percent CH₂═C(CH₃)CO₂CH₂CH₂(CF₂CF₂)ₘF (also referred to as Zonyl® fluoromethacrylate or ZFM) wherein m is from 1 to 12, primarily 2 to 8, and 60 weight percent lauryl methacrylate (CH₂═C(CH₃)CO₂(CH₂)₁₁CH₃, also referred to as LMA).

In some embodiments, the compatibilizer component contains from about 0.01 to 30 weight percent (based on total amount of compatibilizer) of an additive which reduces the surface energy of metallic copper, aluminum, steel, or other metals and metal alloys thereof found in heat exchangers in a way that reduces the adhesion of lubricants to the metal. Examples of metal surface energy reducing additives include those commercially available from DuPont under the trademarks Zonyl® FSA, Zonyl® FSP, and Zonyl® FSJ.

Another non-refrigerant component which may be used with the compositions of the present invention may be a metal surface deactivator. The metal surface deactivator is selected from the group consisting of areoxalyl bis (benzylidene) hydrazide (CAS reg no. 6629-10-3), N,N′-bis(3,5-di-tert-butyl-4-hydroxyhydrocinnamoylhydrazine (CAS reg no. 32687-78-8), 2,2,′-oxamidobis-ethyl-(3,5-di-tert-butyl-4-hydroxyhydrocinnamate (CAS reg no. 70331-94-1), N,N′-(disalicyclidene)-1,2-diaminopropane (CAS reg no. 94-91-7) and ethylenediaminetetra-acetic acid (CAS reg no. 60-00-4) and its salts, and mixtures thereof, meaning mixtures of any of the metal surface deactivators disclosed in this paragraph.

The non-refrigerant component used with the compositions of the present invention may alternatively be a stabilizer selected from the group consisting of hindered phenols, thiophosphates, butylated triphenylphosphorothionates, organo phosphates, or phosphites, aryl alkyl ethers, terpenes, terpenoids, epoxides, fluorinated epoxides, oxetanes, ascorbic acid, thiols, lactones, thioethers, amines, nitromethane, alkylsilanes, benzophenone derivatives, aryl sulfides, divinyl terephthalic acid, diphenyl terephthalic acid, ionic liquids, and mixtures thereof, meaning mixtures of any of the stabilizers disclosed in this paragraph.

The stabilizer may be selected from the group consisting of tocopherol; hydroquinone; t-butyl hydroquinone; monothiophosphates; and dithiophosphates, commercially available from Ciba Specialty Chemicals, Basel, Switzerland, hereinafter “Ciba”, under the trademark Irgalube® 63; dialkylthiophosphate esters, commercially available from Ciba under the trademarks Irgalube® 353 and Irgalube® 350, respectively; butylated triphenylphosphorothionates, commercially available from Ciba under the trademark Irgalube® 232; amine phosphates, commercially available from Ciba under the trademark Irgalube® 349 (Ciba); hindered phosphites, commercially available from Ciba as Irgafos® 168 and Tris-(di-tert-butylphenyl)phosphite, commercially available from Ciba under the trademark Irgafos® OPH; (Di-n-octyl phosphite); and iso-decyl diphenyl phosphite, commercially available from Ciba under the trademark Irgafos® DDPP; trialkyl phosphates, such as trimethyl phosphate, triethylphosphate, tributyl phosphate, trioctyl phosphate, and tri(2-ethylhexyl)phosphate; triaryl phosphates including triphenyl phosphate, tricresyl phosphate, and trixylenyl phosphate; and mixed alkyl-aryl phosphates including isopropylphenyl phosphate (IPPP), and bis(t-butylphenyl)phenyl phosphate (TBPP); butylated triphenyl phosphates, such as those commercially available under the trademark Syn-O-Ad® including Syn-O-Ad® 8784; tert-butylated triphenyl phosphates such as those commercially available under the trademark Durad®620; isopropylated triphenyl phosphates such as those commercially available under the trademarks Durad® 220 and Durad®110; anisole; 1,4-dimethoxybenzene; 1,4-diethoxybenzene; 1,3,5-trimethoxybenzene; myrcene, alloocimene, limonene (in particular, d-limonene); retinal; pinene; menthol; geraniol; farnesol; phytol; Vitamin A; terpinene; delta-3-carene; terpinolene; phellandrene; fenchene; dipentene; caratenoids, such as lycopene, beta carotene, and xanthophylls, such as zeaxanthin; retinoids, such as hepaxanthin and isotretinoin; bornane; 1,2-propylene oxide; 1,2-butylene oxide; n-butyl glycidyl ether; trifluoromethyloxirane; 1,1-bis(trifluoromethyl)oxirane; 3-ethyl-3-hydroxymethyl-oxetane, such as OXT-101 (Toagosei Co., Ltd); 3-ethyl-3-((phenoxy)methyl)-oxetane, such as OXT-211 (Toagosei Co., Ltd); 3-ethyl-3-((2-ethyl-hexyloxy)methyl)-oxetane, such as OXT-212 (Toagosei Co., Ltd); ascorbic acid; methanethiol (methyl mercaptan); ethanethiol (ethyl mercaptan); Coenzyme A; dimercaptosuccinic acid (DMSA); grapefruit mercaptan ((R)-2-(4-methylcyclohex-3-enyl)propane-2-thiol)); cysteine ((R)-2-amino-3-sulfanyl-propanoic acid); lipoamide (1,2-dithiolane-3-pentanamide); 5,7-bis(1,1-dimethylethyl)-3-[2,3(or 3,4)-dimethylphenyl]-2(3H)-benzofuranone, commercially available from Ciba under the trademark Irganox® HP-136; benzyl phenyl sulfide; diphenyl sulfide; diisopropylamine; dioctadecyl 3,3′-thiodipropionate, commercially available from Ciba under the trademark Irganox® PS 802 (Ciba); didodecyl 3,3′-thiopropionate, commercially available from Ciba under the trademark Irganox® PS 800; di-(2,2,6,6-tetramethyl-4-piperidyl)sebacate, commercially available from Ciba under the trademark Tinuvin® 770; poly-(N-hydroxyethyl-2,2,6,6-tetramethyl-4-hydroxy-piperidyl succinate, commercially available from Ciba under the trademark Tinuvin® 622LD (Ciba); methyl bis tallow amine; bis tallow amine; phenol-alpha-naphthylamine; bis(dimethylamino)methylsilane (DMAMS); tris(trimethylsilyl)silane (TTMSS); vinyltriethoxysilane; vinyltrimethoxysilane; 2,5-difluorobenzophenone; 2′,5′-dihydroxyacetophenone; 2-aminobenzophenone; 2-chlorobenzophenone; benzyl phenyl sulfide; diphenyl sulfide; dibenzyl sulfide; ionic liquids; and mixtures and combinations thereof.

The additive used with the compositions of the present invention may alternatively be an ionic liquid stabilizer. The ionic liquid stabilizer may be selected from the group consisting of organic salts that are liquid at room temperature (approximately 25° C.), those salts containing cations selected from the group consisting of pyridinium, pyridazinium, pyrimidinium, pyrazinium, imidazolium, pyrazolium, thiazolium, oxazolium and triazolium and mixtures thereof; and anions selected from the group consisting of [BF₄]—, [PF₆]—, [SbF₆]—, [CF₃SO₃]—, [HCF₂CF₂SO₃]—, [CF₃HFCCF₂SO₃]—, [HCClFCF₂SO₃]—, [(CF₃SO₂)₂N]—, [(CF₃CF₂SO₂)₂N]—, [(CF₃SO₂)₃C]—, [CF₃CO₂]—, and F— and mixtures thereof. In some embodiments, ionic liquid stabilizers are selected from the group consisting of emim BF₄ (1-ethyl-3-methylimidazolium tetrafluoroborate); bmim BF₄ (1-butyl-3-methylimidazolium tetraborate); emim PF₆ (1-ethyl-3-methylimidazolium hexafluorophosphate); and bmim PF₆ (1-butyl-3-methylimidazolium hexafluorophosphate), all of which are available from Fluka (Sigma-Aldrich).

In some embodiments, the stabilizer may be a hindered phenol, which is any substituted phenol compound, including phenols comprising one or more substituted or cyclic, straight chain, or branched aliphatic substituent group, such as, alkylated monophenols including 2,6-di-tert-butyl-4-methylphenol; 2,6-di-tert-butyl-4-ethylphenol; 2,4-dimethyl-6-tertbutylphenol; tocopherol; and the like, hydroquinone and alkylated hydroquinones including t-butyl hydroquinone, other derivatives of hydroquinone; and the like, hydroxylated thiodiphenyl ethers, including 4,4′-thio-bis(2-methyl-6-tert-butylphenol); 4,4′-thiobis(3-methyl-6-tertbutylphenol); 2,2′-thiobis(4methyl-6-tert-butylphenol); and the like, alkylidene-bisphenols including: 4,4′-methylenebis(2,6-di-tert-butylphenol); 4,4′-bis(2,6-di-tert-butylphenol); derivatives of 2,2′- or 4,4-biphenoldiols; 2,2′-methylenebis(4-ethyl-6-tertbutylphenol); 2,2′-methylenebis(4-methyl-6-tertbutylphenol); 4,4-butylidenebis(3-methyl-6-tert-butylphenol); 4,4-isopropylidenebis(2,6-di-tert-butylphenol); 2,2′-methylenebis(4-methyl-6-nonylphenol); 2,2′-isobutylidenebis(4,6-dimethylphenol; 2,2′-methylenebis(4-methyl-6-cyclohexylphenol, 2,2- or 4,4-biphenyldiols including 2,2′-methylenebis(4-ethyl-6-tert-butylphenol); butylated hydroxytoluene (BHT, or 2,6-di-tert-butyl-4-methylphenol), bisphenols comprising heteroatoms including 2,6-di-tert-alpha-dimethylamino-p-cresol, 4,4-thiobis(6-tert-butyl-m-cresol); and the like; acylaminophenols; 2,6-di-tert-butyl-4(N,N′-dimethylaminomethylphenol); sulfides including; bis(3-methyl-4-hydroxy-5-tert-butylbenzyl)sulfide; bis(3,5-di-tert-butyl-4-hydroxybenzyl)sulfide and mixtures thereof, meaning mixtures of any of the phenols disclosed in this paragraph.

The non-refrigerant component which is used with compositions of the present invention may alternatively be a tracer. The tracer may be two or more tracer compounds from the same class of compounds or from different classes of compounds. In some embodiments, the tracer is present in the compositions at a total concentration of about 50 parts per million by weight (ppm) to about 1000 ppm, based on the weight of the total composition. In other embodiments, the tracer is present at a total concentration of about 50 ppm to about 500 ppm. Alternatively, the tracer is present at a total concentration of about 100 ppm to about 300 ppm.

The tracer may be selected from the group consisting of hydrofluorocarbons (HFCs), deuterated hydrofluorocarbons, perfluorocarbons, fluoroethers, brominated compounds, iodated compounds, alcohols, aldehydes and ketones, nitrous oxide and combinations thereof. Alternatively, the tracer may be selected from the group consisting of fluoroethane, 1,1,-difluoroethane, 1,1,1-trifluoroethane, 1,1,1,3,3,3-hexafluoropropane, 1,1,1,2,3,3,3-heptafluoropropane, 1,1,1,3,3-pentafluoropropane, 1,1,1,3,3-pentafluorobutane, 1,1,1,2,3,4,4,5,5,5-decafluoropentane, 1,1,1,2,2,3,4,5,5,6,6,7,7,7-tridecafluoroheptane, iodotrifluoromethane, deuterated hydrocarbons, deuterated hydrofluorocarbons, perfluorocarbons, fluoroethers, brominated compounds, iodated compounds, alcohols, aldehydes, ketones, nitrous oxide (N₂O) and mixtures thereof. In some embodiments, the tracer is a blend containing two or more hydrofluorocarbons, or one hydrofluorocarbon in combination with one or more perfluorocarbons.

The tracer may be added to the compositions of the present invention in predetermined quantities to allow detection of any dilution, contamination or other alteration of the composition.

The additive which may be used with the compositions of the present invention may alternatively be a perfluoropolyether as described in detail in US2007-0284555, incorporated herein by reference.

It will be recognized that certain of the additives referenced above as suitable for the non-refrigerant component have been identified as potential refrigerants. However in accordance with this invention, when these additives are used, they are not present at an amount that would affect the novel and basic characteristics of the refrigerant mixtures of this invention.

In one embodiment, the compositions disclosed herein may be prepared by any convenient method to combine the desired amounts of the individual components. A preferred method is to weigh the desired component amounts and thereafter combine the components in an appropriate vessel. Agitation may be used, if desired.

### Methods and Processes of Use

During regular use of refrigeration, air conditioning, heat pump or power cycle equipment, refrigerant (or working fluid) may escape the system, lowering the performance of the equipment. To restore that performance, new refrigerant may be added to replace that which was lost. Annual refrigerant losses from well-maintained HCFC-123 chiller systems are generally around 1 to 3 weight percent of the refrigerant charge. Accidental discharges may result in larger refrigerant losses, for example 40 weight percent or even total loss of the refrigerant charge. It has been found that replacement of HCFC-123 lost from equipment can be accomplished by adding Z-1,1,1,4,4,4-hexafluoro-2-butene with negligible or only minimal loss in system performance.

In one embodiment, a method is provided for topping-off or replenishing the refrigerant charge. The method comprises adding a second refrigerant to a refrigeration, air conditioning, heat pump or power cycle system containing HCFC-123 as a first refrigerant, wherein said second refrigerant comprises Z-HFO-1336mzz and optionally HCFC-123, thus producing a refrigerant composition comprising the first refrigerant and the second refrigerant.

In one embodiment, the second refrigerant comprises Z-HFO-1336mzz. In another embodiment, the second refrigerant comprises from about 1 to about 99 weight percent Z-HFO-1336mzz and about 99 to about 1 weight percent HCFC-123. In another embodiment, the second refrigerant comprises from about 1 to about 60 weight percent Z-HFO-1336mzz and about 99 to about 40 weight percent HCFC-123. In another embodiment, the second refrigerant comprises from about 1 to about 50 weight percent Z-HFO-1336mzz and about 99 to about 50 weight percent HCFC-123. In another embodiment, the second refrigerant comprises from about 1 to about 40 weight percent Z-HFO-1336mzz and about 99 to about 60 weight percent HCFC-123.

In one embodiment of the method, the second refrigerant comprising Z-HFO-1336mzz and optionally HCFC-123, further comprises at least one hydrocarbon with 3 to 15 carbon atoms. Such hydrocarbons include propane, propylene, cyclopropane and others selected from the group consisting of n-butane, isobutane, n-pentane, isopentane, hexanes, octanes, nonane, and decanes, among others. In another embodiment, the second refrigerant comprising Z-HFO-1336mzz and optionally HCFC-123 further comprises at least one hydrocarbon with 4 to 7 carbon atoms. In particular these hydrocarbons include n-butane, isobutane, n-pentane, isopentane, hexanes and heptanes.

Vapor-compression air conditioning and heat pump systems include an evaporator, a compressor, a condenser, and an expansion device. A refrigeration cycle re-uses refrigerant in multiple steps producing a cooling effect in one step and a heating effect in a different step.

Compressors for use in refrigeration, air conditioning, or heat pump systems include dynamic (e.g. axial or centrifugal) compressors or positive displacement (e.g. reciprocating, screw or scroll) compressors. In one embodiment the refrigeration, air conditioning, or heat pump system comprises a centrifugal compressor. In another embodiment, the refrigeration, air conditioning, or heat pump system comprises a positive displacement compressor.

In one embodiment, the refrigeration, air conditioning, heat pump or power cycle system comprises a centrifugal compressor and the centrifugal compressor includes an impeller.

Expanders for use in power cycle systems include dynamic (e.g. axial or centrifugal) expanders or positive displacement (e.g. reciprocating, screw or scroll) expanders. In one embodiment the power cycle system comprises a centrifugal expander (i.e. a turbine). In another embodiment the power cycle system comprises a positive displacement expander.

In one embodiment of the present method the refrigeration, air conditioning, heat pump or power cycle system comprises a chiller. In another embodiment, the chiller is a centrifugal chiller.

In one embodiment of the present method the refrigeration, air conditioning, heat pump or power cycle system comprises a heat pump. In another embodiment, the heat pump is a centrifugal heat pump.

In one embodiment of the present method the refrigeration, air conditioning, heat pump or power cycle system comprises an organic Rankine cycle system.

In order to gain full benefit from the presently disclosed method, existing equipment containing HCFC-123 as refrigerant will be utilized with a second refrigerant added. The topping-off or replenishing with a second refrigerant must provide performance within certain limits as compared to optimum conditions with the HCFC-123 refrigerant. Therefore, in one embodiment, the average temperature glide remains less than about 1° C. In another embodiment, the average temperature glide remains less than about 0.7° C. In another embodiment, the average temperature glide remains less than about 0.5° C. In another embodiment, the average temperature glide remains less than about 0.15° C.

In one embodiment, the cooling capacity for the system after addition of the second refrigerant remains within about 16% of the cooling capacity for the system operating with a full charge of HCFC-123. In another embodiment, the cooling capacity remains within about 12% of the cooling capacity for the system operating with a full charge of HCFC-123. In another embodiment, the cooling capacity remains within about 8% of the cooling capacity for the system operating with a full charge of HCFC-123. In another embodiment, the cooling capacity remains within about 5% of the cooling capacity for the system operating with a full charge of HCFC-123. In another embodiment, the cooling capacity remains within about 2% of the cooling capacity for the system operating with a full charge of HCFC-123. In another embodiment, the cooling capacity remains within about 1% of the cooling capacity for the system operating with a full charge of HCFC-123.

In one embodiment, when the refrigeration, air conditioning, heat pump or power cycle system comprises a centrifugal compressor, the impeller tip speed for the centrifugal compressor remains within about 10% of the impeller tip speed for the centrifugal compressor in the system operating with a full charge of HCFC-123. In another embodiment, the impeller tip speed for the centrifugal compressor remains within about 7% of the impeller tip speed for the centrifugal compressor in the system operating with a full charge of HCFC-123. In another embodiment, the impeller tip speed for the centrifugal compressor remains within about 5% of the impeller tip speed for the centrifugal compressor in the system operating with a full charge of HCFC-123. In another embodiment, the impeller tip speed for the centrifugal compressor remains within about 3% of the impeller tip speed for the centrifugal compressor in the system operating with a full charge of HCFC-123. In another embodiment, the impeller tip speed for the centrifugal compressor remains within about 2% of the impeller tip speed for the centrifugal compressor in the system operating with a full charge of HCFC-123. In another embodiment, the impeller tip speed for the centrifugal compressor remains within about 1′)/0 of the impeller tip speed for the centrifugal compressor in the system operating with a full charge of HCFC-123.

Vapor compression refrigeration, air conditioning, heat pump or power cycle systems also contain at least one lubricant that functions to lubricate compressor or expander moving parts. Lubricants are chosen based on the refrigerant to be used in the system. A system using HCFC-123 as the refrigerant generally uses mineral oil type lubricants. As Z-HFO-1336mzz is added to such a system as a top-off or replenishment refrigerant (the second refrigerant) miscibility with the mineral oil type lubricants will decrease. In order to maintain proper operation of the system, it may be necessary to add another lubricant that is more miscible with the HFO type refrigerants. Therefore, in one embodiment the method further comprises adding at least one lubricant. In another embodiment, the refrigeration, air conditioning, heat pump or power cycle system contains a first lubricant and the method further comprises replacing at least a portion of the first lubricant with a second lubricant.

In one embodiment, the lubricant to be added is chosen from polyol esters (POE), polyvinyl ethers (PVE), mineral oils or mixtures thereof.

Mechanical vapor-compression refrigeration, air conditioning and heat pump systems include an evaporator, a compressor, a condenser, and an expansion device. A refrigeration cycle re-uses refrigerant in multiple steps producing a cooling effect in one step and a heating effect in a different step. The cycle can be described simply as follows. Liquid refrigerant enters an evaporator through an expansion device, and the liquid refrigerant boils in the evaporator, by withdrawing heat from the environment or a stream or body to be cooled, at a low temperature to form a vapor and produce cooling. Often air or a heat transfer fluid flows over or around the evaporator to transfer the cooling effect caused by the evaporation of the refrigerant in the evaporator to a body to be cooled.

The low-pressure vapor enters a compressor where the vapor is compressed to raise its pressure and temperature. The higher-pressure (compressed) gaseous refrigerant then enters the condenser in which the refrigerant condenses into a liquid refrigerant and discharges its heat to the environment or a stream or body to be heated. The liquid refrigerant returns to the expansion device through which the liquid refrigerant expands from the higher-pressure level in the condenser to the low-pressure level in the evaporator, thus completing the cycle.

A power cycle system includes a heat source, working fluid heater, expander, condenser and a pump. The working fluid is heated by the heat source in the heater. The heated working fluid expands in the expander. The expansion process results in conversion of at least a portion of the heat energy supplied from the heat source into mechanical shaft power. The shaft power can be used to do any mechanical work by employing conventional arrangements of belts, pulleys, gears, transmissions or similar devices depending on the desired speed and torque required. The working fluid still in vapor form that exits the expander continues to the condenser where adequate heat rejection causes the fluid to condense to liquid. The working fluid in liquid form flows to a pump that elevates the pressure of the fluid so that it can be introduced back into the heater thus completing the power cycle loop.

In one embodiment of the method for topping-off or replenishing the refrigerant charge, the refrigeration, air conditioning, heat pump or power cycle system comprises a chiller. In another embodiment, the chiller is a centrifugal chiller.

In another embodiment of the present method the refrigeration, air conditioning, heat pump or power cycle system is a heat pump. In another embodiment, the heat pump is a centrifugal heat pump.

In another embodiment of the present method the refrigeration, air conditioning, heat pump or power cycle system is an organic Rankine cycle system.

A method is provided for replacing HCFC-123 in refrigeration, air conditioning, heat pump or power cycle systems equipment. The method comprises replacing leaked or otherwise lost HCFC-123 with Z-HFO-1336mzz and optionally HCFC-123.

In one embodiment, a method for producing cooling in refrigeration, air conditioning or heat pump equipment suitable for using HCFC-123 as a refrigerant is provided. The method comprises producing cooling in said equipment using a combination of HCFC-123 and Z-HFO-1336mzz as refrigerant. In one embodiment, the refrigerant further comprises at least one hydrocarbon with 3 to 15 carbon atoms. Such hydrocarbons include propane, propylene, cyclopropane and others selected from the group consisting of n-butane, isobutane, n-pentane, isopentane, hexanes, octanes, nonane, and decanes, among others. In another embodiment, the refrigerant further comprises at least one hydrocarbon with 4 to 7 carbon atoms. In particular these hydrocarbons include n-butane, isobutane, n-pentane, isopentane, hexanes and heptanes.

In one embodiment, refrigeration, air conditioning, heat pump or power cycle apparatus containing a refrigerant composition and suitable for using HCFC-123 as the refrigerant is provided. The apparatus is characterized by: containing the refrigerant composition of the present invention consisting of or consisting essentially of HCFC-123 and Z-HFO-1336mzz and optionally at least one hydrocarbon with 3 to 15 carbon atoms, or 4 to 7 carbon atoms.

In one embodiment, disclosed herein is a method for producing cooling comprising condensing a refrigerant composition of the present invention consisting of or consisting essentially of HCFC-123 and Z-HFO-1336mzz and optionally at least one hydrocarbon with 3 to 15 carbon atoms, or 4 to 7 carbon atoms, and thereafter evaporating said refrigerant in the vicinity of a body to be cooled.

A body to be cooled may be defined as any space, location, object, stream or body from which it is desirable to remove heat. Examples include spaces (open or enclosed) requiring refrigeration or cooling, such as refrigerator or freezer cases in a supermarket.

In one embodiment, disclosed herein is a method for producing heating comprising evaporating a refrigerant composition of the present invention consisting of or consisting essentially of HCFC-123 and Z-HFO-1336mzz and optionally at least one hydrocarbon with 3 to 15 carbon atoms, or 4 to 7 carbon atoms, and thereafter compressing and condensing said refrigerant in the vicinity of a body to be heated.

A body to be heated may be defined as any space, location, object, stream or body to which it is desirable to provide heat. Examples include spaces (open or enclosed) requiring heating, such as single family homes, town houses or multiple apartment buildings or public buildings.

For the process for producing cooling, by vicinity is meant that the evaporator of the system containing the refrigerant mixture is located either within or adjacent to the body to be cooled, such that air moving over the evaporator would move into or around the body to be cooled. For the process to produce heating by vicinity is meant that the condenser of the system containing the refrigerant mixture is located either within or adjacent to the body to be heated, such that air moving over the condenser would move into or around the body to be heated.

In some embodiments, the refrigerant mixtures as disclosed herein may be useful in refrigeration applications including medium temperature refrigeration in particular. Medium temperature refrigeration systems includes supermarket and convenience store refrigerated cases for beverages, dairy, fresh food transport and other items requiring refrigeration. Other specific uses may be in commercial, industrial refrigerators and freezers, supermarket rack and distributed systems, walk-in and reach-in coolers and freezers, and combination systems.

In some embodiments, the compositions of the present invention may be useful in air conditioning applications. Air conditioning apparatus may be chillers, heat pumps, residential, commercial or industrial air conditioning systems, and including ductless, ducted, packaged terminal, chillers, and those exterior but connected to the building such as rooftop systems.

In particular the present method for replacing HCFC-123 or topping-off or replenishing a system containing HCFC-123 is particularly useful for large equipment that requires a major investment to replace such as large flooded evaporator chillers and heat pumps. Use of the present methods would allow existing equipment to continue to operate even when HCFC-123 is restricted, available in limited quantities, costly or no longer available for top-off or replenishment of the systems.

In one embodiment is provided a method comprising topping-off or replenishing a refrigeration, air conditioning, heat pump or power cycle system containing HCFC-123 with a refrigerant composition comprising Z-HFO-1336mzz and optionally HCFC-123 and optionally at least one hydrocarbon with 3 to 15 carbon atoms, or 4 to 7 carbon atoms.

In another embodiment is provided a method comprising replacing HCFC-123 in a refrigeration, air conditioning, heat pump or power cycle system with a refrigerant composition comprising Z-HFO-1336mzz and optionally HCFC-123 and optionally at least one hydrocarbon with 3 to 15 carbon atoms, or 4 to 7 carbon atoms. In another embodiment of the method for replacing, the refrigeration, air conditioning, heat pump or power cycle system comprises a centrifugal compressor. In another embodiment, of the method for replacing, the impeller tip speed for the centrifugal compressor remains within 10% of the impeller tip speed for the centrifugal compressor in the system operating with a full charge of HCFC-123.

In another embodiment is provided a method for replacing a refrigerant in a refrigeration, air conditioning, heat pump or power cycle system that contains HCFC-123 and a lubricant, said method comprising removing the HCFC-123 from the refrigeration or air conditioning or heat pump or power cycle system while retaining a substantial portion of the lubricant in said system and introducing a composition comprising Z-HFO-1336mzz and HCFC-123 and optionally at least one hydrocarbon with 3 to 15 carbon atoms, or 4 to 7 carbon atoms and optionally additional lubricant to the refrigeration, air conditioning, heat pump or power cycle system.

In another embodiment is provided a method for replacing a refrigerant in a refrigeration, air conditioning, heat pump or power cycle system that contains HCFC-123 and a lubricant, said method comprising removing the HCFC-123 and the lubricant from the refrigeration or air conditioning or heat pump or power cycle system and introducing a composition comprising Z-HFO-1336mzz and HCFC-123 and optionally at least one hydrocarbon with 3 to 15 carbon atoms, or 4 to 7 carbon atoms and lubricant to the refrigeration, air conditioning, heat pump or power cycle system where the lubricant introduce is selected from the group consisting of mineral oils, POEs, PVEs, PAGs and mixtures thereof.

### Apparatus

In one embodiment, a refrigeration, air conditioning, heat pump or power cycle system comprising a composition disclosed herein comprising Z-HFO-1336mzz and HCFC-123 and optionally at least one hydrocarbon with 3 to 15 carbon atoms, or 4 to 7 carbon atoms. Said systems may include condensing units, residential air conditioners, residential heat pumps, commercial or industrial centrifugal or screw chillers, commercial or industrial centrifugal or screw heat pumps, and Rankine cycle systems.

In one embodiment, there is provided a refrigeration or air conditioning apparatus containing a composition as disclosed herein. In another embodiment is disclosed a refrigeration apparatus containing a composition as disclosed herein. In another embodiment is disclosed an air conditioning apparatus containing a composition as disclosed herein. In another embodiment is disclosed a heat pump apparatus containing a composition as disclosed herein. The refrigeration, air conditioning and heat pump apparatus typically includes an evaporator, a compressor, a condenser, and an expansion device.

In another embodiment is disclosed a power cycle system apparatus containing a composition as disclosed herein. The apparatus typically includes an evaporator, an expander, a condenser, and a liquid pump.

In one embodiment is provided a refrigeration, air conditioning, heat pump or power cycle system comprising a chiller containing a composition as disclosed herein. In another embodiment, the chiller is a centrifugal chiller.

In one embodiment, is provided a refrigeration, air conditioning, heat pump or power cycle system comprising a heat pump containing a composition as disclosed herein. In another embodiment, the heat pump is a centrifugal heat pump.

In one embodiment, is provided a refrigeration, air conditioning, heat pump or power cycle system comprising an organic Rankine cycle system.

### EXAMPLES

The concepts disclosed herein will be further described in the following examples, which do not limit the scope of the invention described in the claims.

### Example 1

### Restoration of HCFC-123 Chiller Performance by Replenishing HCFC-123 Loss with Z-HFO-1336mzz

It is assumed that a centrifugal chiller operating with HCFC-123 has gradually or accidentally lost about 10 weight percent of its HCFC-123 charge. As a result, the chiller underperforms relative to operation with a full HCFC-123 charge. One reason, for example, that a chiller with a suboptimal amount of refrigerant could underperform is that some of the evaporator heat exchange tubes are not immersed in the evaporator refrigerant pool. Adding Z-HFO-1336mzz to the chiller working fluid charge to replenish the lost HCFC-123 (e.g. to ensure that all heat transfer tubes in the evaporator are just fully immersed) would effectively restore chiller performance to the level realized with a full charge of HCFC-123. According to Table 1, adding an amount of Z-HFO-1336mzz to the chiller so that the resulting HCFC-123/Z-HFO-1336mzz refrigerant charge contains about 10 weight percent Z-HFO-1336mzz would lead to a value of COP for cooling within 0.37% of the COP for cooling with neat HCFC-123 and a volumetric cooling capacity about 1.68% higher than the volumetric cooling capacity with neat HCFC-123. Moreover, it would lead to negligible condenser and evaporator glide values as well as a negligible deviation of the required impeller tip speed from the value required with neat HCFC-123. Adequate compatibility of the resulting HCFC-123/Z-HFO-1336mzz blend with the chiller lubricant and materials of construction must be ensured.

TABLE 1
Predicted performance of chillers operating with HCFC-123/Z-HFO-
1336mzz blends containing up to 40 wt % Z-HFO-1336mzz
(Tₑᵥₐₚₒᵣₐₜₒᵣ = 4.44° C.; T_{condenser} = 37.78° C.; Superheat = 0° C.;
Subcooling = 0° C.; Compressor Efficiency = 70%).

| | | | | | | |
|---|---|---|---|---|---|---|
| HCFC-123 wt % | | 100 | 90 | 80 | 70 | 60 |
| Z-HFO-1336mzz wt % | | 0 | 10 | 20 | 30 | 40 |
| Blend GWP | | 77 | 70 | 63 | 57 | 50 |
| Blend ODP | | 0.020 | 0.018 | 0.016 | 0.014 | 0.012 |
| P_{cond} | Pa | 143,772.52 | 146,880.63 | 148,624.87 | 149,004.57 | 148,002.95 |
| Pₑᵥₐₚ | Pa | 39,867.75 | 40,818.13 | 41,329.47 | 41,363.93 | 40,898.98 |
| COP_{cooling} | | 5.103 | 5.084 | 5.066 | 5.049 | 5.033 |
| COP_{cooling} vs HCFC- | % | 0.00 | −0.37 | −0.73 | −1.06 | −1.37 |
| 123 | | | | | | |
| CAP_{cooling} | kJ/m³ | 386.51 | 393.00 | 395.76 | 394.81 | 390.13 |
| CAP_{cooling} vs HCFC- | % | 0.00 | 1.68 | 2.39 | 2.15 | 0.94 |
| 123 | | | | | | |
| Condenser Glide | ° C. | 0.00 | 0.08 | 0.03 | 0.00 | 0.09 |
| Evaporator Glide | ° C. | 0.00 | 0.06 | 0.01 | 0.01 | 0.13 |
| Uₜᵢₚ | m/s | 189.42 | 188.40 | 187.56 | 186.88 | 186.47 |
| Uₜᵢₚ vs HCFC-123 | % | 0.00 | −0.53 | −0.98 | −1.34 | −1.56 |

TABLE 2
Predicted chiller performance of HCFC-123/Z-HFO-1336mzz
blends with Z-HFO-1336mzz content exceeding 40 wt %
(Tₑᵥₐₚₒᵣₐₜₒᵣ = 4.44° C.; T_{condenser} = 37.78° C.; Superheat = 0° C.;
Subcooling = 0° C.; Compressor Efficiency = 70%).

| | | | | | | | |
|---|---|---|---|---|---|---|---|
| HCFC-123 wt % | | 50 | 40 | 30 | 20 | 10 | 0 |
| Z-HFO- | | 50 | 60 | 70 | 80 | 90 | 100 |
| 1336mzz | | | | | | | |
| wt % | | | | | | | |
| Blend | | 43 | 36 | 30 | 23 | 16 | 9 |
| GWP | | | | | | | |
| Blend | | 0.010 | 0.008 | 0.006 | 0.004 | 0.002 | 0.000 |
| ODP | | | | | | | |
| P_{cond} | Pa | 145,678.79 | 142,174.74 | 137,653.42 | 132,231.60 | 125,948.90 | 118,760.74 |
| Pₑᵥₐₚ | Pa | 39,964.40 | 38,636.99 | 36,999.79 | 35,118.24 | 33,044.19 | 30,830.42 |
| COP_{cooling} | | 5.019 | 5.008 | 4.999 | 4.991 | 4.983 | 4.977 |
| COP_{cooling} | % | −1.65 | −1.86 | −2.04 | −2.19 | −2.35 | −2.47 |
| vs HCFC- | | | | | | | |
| 123 | | | | | | | |
| CAP_{cooling} | kJ/m³ | 382.00 | 370.95 | 357.42 | 341.68 | 323.86 | 304.14 |
| CAP_{cooling} | % | −1.17 | −4.03 | −7.53 | −11.60 | −16.21 | −21.31 |
| vs HCFC- | | | | | | | |
| 123 | | | | | | | |
| Condenser | ° C. | 0.31 | 0.59 | 0.83 | 0.90 | 0.68 | 0.00 |
| Glide | | | | | | | |
| Evaporator | ° C. | 0.38 | 0.66 | 0.86 | 0.87 | 0.60 | 0.00 |
| Glide | | | | | | | |
| Uₜᵢₚ | m/s | 186.33 | 186.37 | 186.54 | 186.74 | 186.91 | 186.91 |
| Uₜᵢₚ vs | % | −1.63 | −1.61 | −1.52 | −1.41 | −1.32 | −1.32 |
| HCFC-123 | | | | | | | |

The data in Table 2 indicate that the performance of the chiller would be maintained for even up to 60 weight percent Z-HFO-1336mzz with less than 5% reduction in cooling capacity (CAP_{cooling}) and less than 2%, reduction in COP. Extrapolating the data would suggest that at about 75 weight percent Z-HFO-1336mzz, the cooling capacity would still be reduced only by less than 10% from the value with neat HCFC-123 working fluid. Thus, the use of Z-HFO-1336mzz would allow the maintenance and operation of equipment originally designed for HCFC-123 and delay the high cost of replacing such equipment due to regulatory restrictions, or unavailability of HCFC-123.

It was found that HCFC-123/Z-HFO-1336mzz blends with up to about 40 mol % (41.7 wt %) Z-HFO-1336mzz are nearly azeotropic as indicated by the condenser and evaporator temperature glide for chillers operated under typical conditions. Moreover, it was found that chiller performance with HCFC-123/Z-HFO-1336mzz blends containing up to about 40 wt % Z-HFO-1336mzz is similar to chiller performance with neat HCFC-123, as shown in Table 1. The HCFC-123/Z-HFO-1336mzz blends in Table 1 exhibit condenser pressures sufficiently low to not require pressure rated vessels according to the ASME Boiler and Pressure Vessel Code in many geographic regions and evaporator and condenser temperature glide values sufficiently low to be acceptable for flooded heat exchangers. Furthermore, the HCFC-123/Z-HFO-1336mzz blends in Table 1 enable chiller energy efficiencies for cooling (as quantified by the chiller COP for cooling) within about 1.4% of the energy efficiency with neat HCFC-123 and volumetric cooling capacities up to about 2.4% higher than the volumetric cooling capacity with neat HCFC-123. The HCFC-123/Z-HFO-1336mzz blends in Table 1, when used in centrifugal chillers, would require impeller tip speeds within about 1.5% of the tip speed required with neat HCFC-123 to lift the working fluid from the thermodynamic state of the evaporator to that of the condenser. It can be concluded that HCFC-123/Z-HFO-1336mzz blends containing up to about 40 wt % Z-HFO-1336mzz would enable acceptable performance as working fluids for most chillers designed for and operated with neat HCFC-123 as the working fluid. Gradual annual refrigerant losses from HCFC-123 chillers can be limited to below 1 wt % of the chiller charge. Therefore, replenishing HCFC-123 losses with Z-HFO-1336mzz could effectively maintain chiller performance for up to 40 yrs or the remaining chiller useful life, whichever is shorter.

It is possible that accidental losses of HCFC-123 can exceed 40 wt % of a chiller's HCFC-123 charge. Table 2 summarizes chiller performance with HCFC-123/Z-HFO-1336mzz blends containing more than 40 wt % Z-HFO-1336mzz. Chiller performance with HCFC-123/Z-HFO-1336mzz blends gradually deteriorates with increasing Z-HFO-1336mzz content above about 40 wt %. However, it may still be acceptable in many cases to use HCFC-123/Z-HFO-1336mzz blends with Z-HFO-1336mzz content higher than 40 wt % as HCFC-123 chiller working fluids to at least partially restore chiller operation after large HCFC-123 charge losses and, thereby, extend chiller life.

The method of this invention could also be applied to equipment other than chillers (e.g. heat pumps or Rankine cycle systems operating with HCFC-123, equipment using HCFC-123 as a heat carrier etc.).

### Example 2

### Restoration of HCFC-123 Chiller Performance by Replenishing HCFC-123 Loss with Z-HFO-1336Mzz

It is assumed that a centrifugal chiller operating with HCFC-123 has gradually or accidentally lost about 10 wt % of its HCFC-123 charge. As a result, the chiller underperforms relative to operation with a full HCFC-123 charge. One reason, for example, that a chiller with a suboptimal amount of refrigerant could underperform is that some of the evaporator heat exchange tubes are not immersed in the evaporator refrigerant pool. Adding Z-HFO-1336mzz to the chiller working fluid charge to replenish the lost HCFC-123 (e.g. to ensure that all heat transfer tubes in the evaporator are just fully immersed) would effectively restore chiller performance to the level realized with a full charge of HCFC-123. According to Table 1, adding an amount of Z-HFO-1336mzz to the chiller so that the resulting HCFC-123/Z-HFO-1336mzz refrigerant charge contains about 10 wt % Z-HFO-1336mzz would lead to a value of COP for cooling within 0.37% of the COP for cooling with neat HCFC-123 and a volumetric cooling capacity about 1.68% higher than the volumetric cooling capacity with neat HCFC-123. Moreover, it would lead to negligible condenser and evaporator glide values as well as a negligible deviation of the required impeller tip speed from the value required with neat HCFC-123. Adequate compatibility of the resulting HCFC-123/Z-HFO-1336mzz blend with the chiller lubricant and materials of construction must be ensured.

### SELECTED EMBODIMENTS

### Embodiment A1

A composition comprising Z-1,1,1,4,4,4-hexafluoro-2-butene (Z-HFO-1336mzz) and 2,2-dichloro-1,1,1-trifluoroethane (HCFC-123).

### Embodiment A2

The composition of Embodiment A1 comprising an azeotropic or azeotrope-like combination of from about 1 weight percent to about 99 weight percent Z-HFO-1336mzz and from about 99 weight percent to about 1 weight percent HCFC-123.

### Embodiment A3

The composition of any of Embodiments A1-A2 comprising from about 1 to about 42 weight percent Z-HFO-1336mzz and about 99 to about 58 weight percent HCFC-123.

### Embodiment A4

The composition of any of Embodiments A1-A3, further comprising at least one hydrocarbon with 3 to 15 carbon atoms.

### Embodiment A5

The composition of any of Embodiments A1-A4, further comprising at least one lubricant suitable for use in a refrigeration, air conditioning, heat pump or power cycle system.

### Embodiment A6

The composition of Embodiment AS wherein the at least one lubricant is selected from the group of mineral oils, POEs, PVEs and mixtures thereof.

### Embodiment B1

A method comprising adding a second refrigerant to a refrigeration, air conditioning, heat pump or power cycle system containing HCFC-123 as a first refrigerant, wherein said second refrigerant comprises Z-HFO-1336mzz and optionally HCFC-123, thus producing a refrigerant composition comprising the first refrigerant and the second refrigerant.

### Embodiment B2

The method of Embodiments B1, wherein the second refrigerant further comprises at least one hydrocarbon with 3 to 15 carbon atoms.

### Embodiment B3

The method of any of Embodiments B1-B2 wherein the refrigeration, air conditioning, heat pump or power cycle system comprises a centrifugal compressor and the centrifugal compressor includes an impeller.

### Embodiment B4

The method of any of Embodiments B1-B3 wherein the average temperature glide remains less than 1° C.

### Embodiment B5

The method of any of Embodiments B3-B4, wherein the impeller tip speed for the centrifugal compressor remains within 10% of the impeller tip speed for the centrifugal compressor in the system operating with a full charge of HCFC-123.

### Embodiment B6

The method of any of Embodiments B1-B5, further comprising adding at least one lubricant.

### Embodiment B7

The method of any of Embodiments B1-B6, wherein the refrigeration, air conditioning, heat pump or power cycle system also contains a first lubricant, the method further comprising replacing at least a portion of the first lubricant with a second lubricant.

### Embodiment B8

The method of any of Embodiments B1-B7, wherein the at least one lubricant is chosen from polyol esters, polyvinyl ethers, mineral oils or mixtures thereof.

### Embodiment B9

The method of any of Embodiments B1-B7, wherein the second lubricant is chosen from polyol esters, polyvinyl ethers, mineral oils or mixtures thereof.

### Embodiment B10

The method of any of Embodiments B1-B9, wherein the refrigeration, air conditioning, heat pump or power cycle system comprises a chiller.

### Embodiment B11

The method of any of Embodiments B1-B10, wherein the cooling capacity for the system after addition of the second refrigerant remains within 16% of the cooling capacity for the system operating with a full charge of HCFC-123.

### Embodiment B12

The method of any of Embodiments B1-B11, wherein the chiller is a centrifugal chiller.

### Embodiment B13

The method of any of Embodiments B1-B12, wherein the refrigeration, air conditioning, heat pump or power cycle system is a heat pump.

### Embodiment B14

The method of any of Embodiments B1-B13, wherein the heat pump is a centrifugal heat pump.

### Embodiment B15

The method of any of Embodiments B1-B14, wherein the refrigeration, air conditioning, heat pump or power cycle system is an organic Rankine cycle system.

### Embodiment C1

A method comprising replacing HCFC-123 in a refrigeration, air conditioning, heat pump or power cycle system with a refrigerant composition comprising Z-HFO-1336mzz and optionally HCFC-123.

### Embodiment C2

The method of Embodiment C1, wherein the refrigerant composition further comprises at least one hydrocarbon with 3 to 15 carbon atoms.

### Embodiment C3

The method of any of Embodiments C1-02, wherein the refrigeration, air conditioning, heat pump or power cycle system comprises a centrifugal compressor and the centrifugal compressor includes an impeller.

### Embodiment C4

The method of any of Embodiments C1-C3, wherein the impeller tip speed for the centrifugal compressor remains within 10% of the impeller tip speed for the centrifugal compressor in the system operating with a full charge of HCFC-123.

What is claimed is:

1. A composition comprising Z-1,1,1,4,4,4-hexafluoro-2-butene (Z-HFO-1336mzz) and 2,2-dichloro-1,1,1-trifluoroethane (HCFC-123).

2. The composition of claim 1 comprising an azeotropic or azeotrope-like combination of from about 1 weight percent to about 99 weight percent Z-HFO-1336mzz and from about 99 weight percent to about 1 weight percent HCFC-123.

3. The composition of claim 2 comprising from about 1 to about 42 weight percent Z-HFO-1336mzz and about 99 to about 58 weight percent HCFC-123.

4. The composition of claim 1, further comprising at least one hydrocarbon with 3 to 15 carbon atoms.

5. The composition of claim 1 further comprising at least one lubricant suitable for use in a refrigeration, air conditioning, heat pump or power cycle system.

6. The composition of claim 5 wherein the at least one lubricant is selected from the group of mineral oils, POEs, PVEs and mixtures thereof.

7. A method comprising:
adding a second refrigerant to a refrigeration, air conditioning, heat pump or power cycle system containing HCFC-123 as a first refrigerant, wherein said second refrigerant comprises Z-HFO-1336mzz and optionally HCFC-123, thus producing a refrigerant composition comprising the first refrigerant and the second refrigerant.

8. The method of claim 7, wherein the second refrigerant further comprises at least one hydrocarbon with 3 to 15 carbon atoms.

9. The method of claim 7 wherein the refrigeration, air conditioning, heat pump or power cycle system comprises a centrifugal compressor and the centrifugal compressor includes an impeller.

10. The method of claim 7 wherein the average temperature glide remains less than 1° C.

11. The method of claim 9, wherein the impeller tip speed for the centrifugal compressor remains within 10% of the impeller tip speed for the centrifugal compressor in the system operating with a full charge of HCFC-123.

12. The method of claim 7, further comprising adding at least one lubricant.

13. The method of claim 7, wherein the refrigeration, air conditioning, heat pump or power cycle system also contains a first lubricant, the method further comprising replacing at least a portion of the first lubricant with a second lubricant.

14. The method of claim 12, wherein the at least one lubricant is chosen from polyol esters, polyvinyl ethers, mineral oils or mixtures thereof.

15. The method of claim 13, wherein the second lubricant is chosen from polyol esters, polyvinyl ethers, mineral oils or mixtures thereof.

16. The method of claim 7, wherein the refrigeration, air conditioning, heat pump or power cycle system comprises a chiller.

17. The method of claim 14 wherein the cooling capacity for the system after addition of the second refrigerant remains within 16% of the cooling capacity for the system operating with a full charge of HCFC-123.

18. The method of claim 16, wherein the chiller is a centrifugal chiller.

19. The method of claim 7, wherein the refrigeration, air conditioning, heat pump or power cycle system is a heat pump.

20. The method of claim 14, wherein the heat pump is a centrifugal heat pump.

21. The method of claim 7, wherein the refrigeration, air conditioning, heat pump or power cycle system is an organic Rankine cycle system.

22. A method comprising:
replacing HCFC-123 in a refrigeration, air conditioning, heat pump or power cycle system with a refrigerant composition comprising Z-HFO-1336mzz and optionally HCFC-123.

23. The method of claim 22, wherein the refrigerant composition further comprises at least one hydrocarbon with 3 to 15 carbon atoms.

24. The method of claim 22, wherein the refrigeration, air conditioning, heat pump or power cycle system comprises a centrifugal compressor and the centrifugal compressor includes an impeller.

25. The method of claim 24, wherein the impeller tip speed for the centrifugal compressor remains within 10% of the impeller tip speed for the centrifugal compressor in the system operating with a full charge of HCFC-123.
